(19) United States
(12) Patent Application Publication
(10) Pub. No.: US 2007/0110214 A1
(43) Pub. Date: May 17, 2007

(54) Methods of characterizing compositions

(76) Inventor: Simon Bates, West Lafayette, IN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/525,930

(22) Filed: Sep. 25, 2006

Related U.S. Application Data
(60) Provisional application No. 60/719,965, filed on Sep. 26, 2005.
(60) Provisional application No. 60/838,144, filed on Aug. 17, 2006.

(51) Int. Cl. G01N 23/223

(52) U.S. Cl. 378/45

(57) ABSTRACT

The present invention is directed to methods for characterizing the structure of compositions such as amorphous, crystalline, and combinations thereof. The methods are directed to analyzing pairwise distribution function plots of the components of the compositions and comparing them to the pairwise distribution function plot of the composition.

### METHODS OF CHARACTERIZING COMPOSITIONS

This application claims the benefit of priority to U.S. provisional application No. 60/719,965, filed on Sep. 26, 2005, and to U.S. provisional application No. 60/838,144, filed on Aug. 17, 2006, the contents of both of which are incorporated by reference herein.

Pharmaceuticals are often formulated from crystalline compounds because crystalline materials typically provide high levels of purity and are resistant to physical and chemical instabilities under ambient conditions. Unlike a crystalline solid, which has an orderly array of unit cells in three dimensions, an amorphous form lacks long-range order because molecular packing is more random. Amorphous organic compounds tend to have different properties than their crystalline counterparts. For example, amorphous compounds tend to have greater solubility than crystalline forms of the same compound (Hancock and Parks, Pharmaceutical Res. 17, 397 (2000)). Thus, for example, in pharmaceutical formulations whose crystalline forms are poorly soluble, amorphous forms often present attractive formulation options. Thus, amorphous active pharmaceutical ingredients (“API”) are often used to improve physical and chemical properties of drugs.

When preparing amorphous drug products, it is often desirable to prepare a composition of the active pharmaceutical ingredient with a stabilizer which stabilizes the amorphous state against crystallization. Such stabilizers are often selected from polymers, celluloses, and organic acids. Examples of such excipients include polyvinyl pryrollidone (PVP), hydroxypropylmethyl cellulose (HPMC), and citric acid. Intimate mixing between such excipients and the amorphous API is an important factor in compositions resistant to crystallization. These intimate mixtures are often referred to as “dispersions” or “solid dispersions.” Because crystalline forms are more thermodynamically stable than amorphous forms, there is a driving force for crystallizing the amorphous state for any given compound or mixtures of compounds. Thus, stabilizers such as PVP are used to help reduce the possibility of such crystallizations but are dependent upon good and intimate mixing with, for example, an active pharmaceutical ingredient. It would be advantageous to have a description of the structure of such compositions so as to enable one to understand and optimize their properties.

### SUMMARY OF THE INVENTION

In one aspect of the invention, methods for characterizing a composition are provided comprising linearly combining pairwise distribution function plots of principal components of the composition and comparing the plots with the pairwise distribution function plot of the composition to obtain a description of the composition.

In another aspect of the invention, methods for characterizing a composition are provided comprising obtaining a pairwise distribution function plot for the composition, obtaining pairwise distribution plot for each of the principal components of the composition wherein the plot for at least one principal component is derived; linearly combining the pairwise distribution function plots of the principal components and comparing them with the pairwise distribution function plot of the composition to obtain a description of the structure of the composition.

In yet another aspect of the invention, methods for characterizing a composition are provided wherein a powder x-ray diffraction pattern is collected on the composition; a powder x-ray diffraction pattern is collected on each of the principal components of the composition; the x-ray powder diffraction patterns of the composition and each of the principal components of the composition are transformed into pairwise distribution function plots, and a linear combination of the component pairwise distribution function plots is compared with the pairwise distribution function plot of the composition to obtain a description of the structure of the composition.

Additional objects and advantages of the invention are set forth in the following description. Both the foregoing general summary and the following detailed description are exemplary only and are not restrictive of the invention as claimed. Further features and variations may be provided in addition to those set forth in the description. For instance, the present invention includes various combinations and subcombinations of the features disclosed in the detailed description. In addition, it will be noted that the order of the steps presented need not be performed in that order in order to practice the invention. For example, the pairwise distribution function plots may be obtained in any order.

### BRIEF DESRIPTION OF THE DRAWINGS

FIG. 1 is a schematic illustrating one embodiment of performing a linear combination comparison of the invention.

FIG. 2 is an x-ray diffraction pattern of amorphous indomethacin prepared according to example 1.

FIG. 3 is an x-ray diffraction pattern of a 70:30 (w:w) Indomethacin:PVP Dispersion mixture

FIG. 4 is an x-ray diffraction pattern of a 30:70 (w:w) Indomethacin:PVP Dispersion mixture

FIG. 5 is a linear combination analysis of PDF plots of a 70:30 (w:w) Indomethacin:PVP Dispersion mixture

FIG. 6 is a linear combination analysis of PDF plots of a 30:70 (w:w) Indomethacin:PVP Dispersion mixture.

### DETAILED DESCRIPTION

This invention relates to characterizing compositions in the solid form using the pairwise distribution function. Such compositions comprise two or more principal component chemical compounds, such as three or four or five or more principal component compositions. Examples of chemical compounds include, for example, pharmaceutical compounds. The compositions of the invention may be crystalline, amorphous, or a combination thereof.

Compounds of the invention include salts of chemical compounds, for instance pharmaceutical compounds as pharmaceutically acceptable salts. They also include mixtures of two or more chemical compounds.

The compounds of the invention may be crystalline or x-ray amorphous solid forms. Examples of solid forms of the invention include, for example, cocrystals, hydrates, solvates, polymorphs, dehydrated hydrates, desolvated solvates, molecular complexes, and clathrates.

When the compositions of the invention are amorphous, they typically also comprise one or more stabilizers, which are used to inhibit or retard crystallization of the other component or components of the composition.

The term “principal component” as used herein relates to the majority components of the composition and may be, for example, organic compounds. In other words, it is not necessary to know the identity or measure all components of the composition. For example, impurities are not considered principal components nor are compound such as lubricants or emulsifiers. By way of further example, in the pharmaceutical dispersion context, principal components would be considered APIs present as well as any stabilizing agents. Additionally, the methods of the invention operate even when not all of the principal components are known or measured provided that a PDF plot is available for all but one of the principal components.

The term “characterizing” as used herein relates to analyzing the structure of the composition in order to obtain a description of the structure of the composition. Such analysis may involve determining, for example, the nature and degree of the amorphous or crystalline nature of an amorphous composition. In the context of analyzing what is purportedly a pharmaceutical dispersion formulation, for example, this analysis can then be used to evaluate the stability of the formulation. In such a purported dispersion, the characterization may reveal a description of the composition indicating that the composition is phase separated and thus not a dispersion. By “phase separated” what is meant is that the principal components are not intimately mixed and the ability of, for example, a polymer to inhibit crystallization of an API is diminished.

Alternatively, the characterization may reveal a structure that is a solid dispersion. The structures of such dispersions fall into several subcategories: a solid solution, a preferred bonded composition, or a synthon solid solution. That is, the description of the structure of the composition may be phase separated, solid solution, preferred bonded composition, solid solution, or another description of the structure of the composition. When making a pharmaceutical dispersion formulation, it is desirable to have a solid dispersion because such a dispersion more effectively inhibits crystallization than a phase separated system or a dispersion that is not a solid solution. Solid solutions provide the most intimate mixing of the three types of dispersions which is why they inhibit crystallization more effectively than the other kinds of dispersions.

In a preferred bonded composition, the synthon making up the amorphous composition is a mixture of the components. By “synthon” what is meant is the molecular unit corresponding to the smallest molecular structure in non-crystalline solid states. It is approximately equivalent to the unit cell construct in crystalline solids. In the synthon solid solution, there is one synthon for each component. In other words, it can be viewed as a nanoscopic suspension of two x-ray amorphous solids.

At the molecular level, dispersions and phase separated dispersions can be viewed as having several intermolecular interactions. In embodiments where there are two principal component compounds, for example, there are three principal intermolecular coordination interactions. These interactions are called host-host, guest-guest, and host-guest. In many cases, the host will be the majority component. In purportedly amorphous pharmaceutical composition, the host is typically an API and the guest a stabilizer. For example, in an Indomethacin:PVP composition, indomethacin is the host and PVP is the guest.

These interactions can be measured and scale with the intensity of a PDF plot and the ratios of the contributions from each of the intermolecular components depend on the thermodynamic nature of the mixture and the molar ratios of the components. For example, in a 1:1 molar ratio of host compound to guest compound in a mixture with strong specific interactions between host and guest, it is expected that the host-guest component will dominate. Phase-separated mixtures would be dominated by host-host and guest-guest interactions and would be essentially a linear combination of the component PDF plots. Host-guest interactions are more significant for dispersions, because they have more intimate host-guest contact interactions than phase separated compositions.

In one embodiment of the invention, a pharmaceutical composition comprising at least one stabilizing agent and at least one API is characterized to obtain a description of the structure of the composition.

When attempting to make a solid dispersion of an API and, for example, a stabilizing agent, one may actually make a phase separated composition, a solid solution, a preferred bonded composition, or a synthon solution. In one embodiment of the invention, one of ordinary skill in the art practicing the invention can characterize a composition containing one API and one stabilizing agent by linearly combining the PDF plots corresponding to the API with that of the stabilizing agent and compare them to the PDF plot of the composition in order to obtain a description of the structure of the composition.

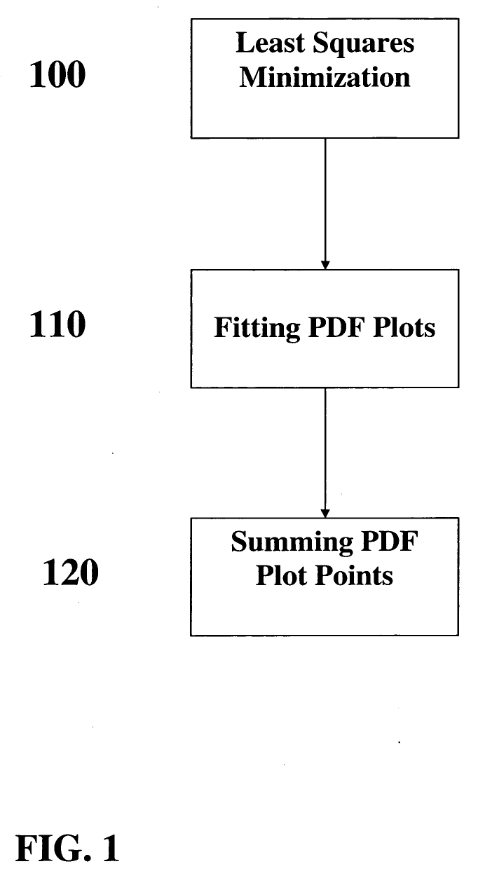

The comparison may be done by multiplying the PDFs of the two components by different scalars until the sum of the two matches the PDF plot of the composition. This comparison may be done manually or automatically by computer. In performing the comparison, one typically attempts to minimize the difference between the sum of the component PDFs and the composition PDF is on the order of the precision of the method used to calculate the PDF plots. The comparison then provides a description of the structure of the composition. FIG. 1 is a schematic illustrating the fitting process.

In step 100, a least squares minimization of scale factors of the component PDF plots is performed. This selects the scalars by which to multiply the component PDF plots to provide a fit to the measured PDF plot of the dispersion. In step 110, the fit is done in such a way that the residual, which is the difference between the sum of the scaled component PDF plots and the dispersion plots, is minimized. In step 120, the intensities of the component PDF plots and the dispersion PDF plots are obtained by summing the absolute values of each of the points within a single PDF plot and comparing that sum to the sums for the other components including the residual. If the residual sum is on the order of the precision of the method used to calculate the PDF plots of the components and the composition, then the dispersion is either a phase separated composition or a synthon solution composition. The residual represents the intensity of inter-component interactions. For example, in a PVP:indomethacin dispersion, it would represent contributions from PVP-indomethacin interactions. These two compositions can be differentiated by measuring their respective glass transition temperatures.

If, however, the residual is greater than the precision of the method used to calculate the PDF plots of the components and the composition, then the composition is either a solid solution or a preferred bonding composition. In a solid solution, one would expect contributions from the principal components and from the residual. That is, the fit would have PDF plot intensity from the PDF plots of the principal components and from the PDF plot of the residual. The relative contributions of the principal components and residual in the PDF plot would scale with the relative amount of the principal components present.

In a preferred bonding composition, sometimes referred to as an “amorphous cocrystal”, the intercomponent interactions dominate. That is, the residual PDF plot would be significantly higher than either of the individual component PDF plots. For example, in a 1:1 preferred bonding composition dispersion of two different components, the majority component after performing a linear combination would be the residual PDF plot with only negligible intensity from either of the component PDF plots.

Because PDF plot intensity scales with amount of material, different intensities would be expected for dispersions with different weight percent of components. That is, one of ordinary skill in the solid-state analytical arts would, upon knowing the weight percent makeup of the constitution (the relative weight percent of each of the principal components) be able to calculate the relative contributions of each of the principal component interactions in describing the structure of the composition. An example of this calculation can be found in example 8 wherein the percent indomethacin-indomethacin, PVP-PVP, and indomethacin-PVP contributions were calculated for two different dispersions.

In one embodiment of the invention, the composition comprises an API and a polymer. In this embodiment, clusters of API may become embedded within the polymer matrix thereby providing discrete domains of API on the one hand and polymer on the other. This describes the synthon solution state. In these circumstances, the PDF plots of the components would be able to be linearly combined with each other and would arrive at a fit with the composition wherein the residual would be on the order of the precision of the method used to calculate the PDF plots. The same result would be obtained if the API domains are sufficiently large, such that crystallization may initiate, which describes the phase separated state. The two states may be distinguished from each other by thermal means. The phase separated state will yield two glass transition temperatures, if both components remain substantially amorphous, whereas the synthon solution state would have only one. In both the phase separated state and the synthon solution state, the interactions between the API and polymer are often weak compared to solid solution and only occur in the interface regions between the API and polymer domains. Thus, the dominant coherent atom-atom pair interactions will be API-API, which are host-host interactions, and polymer-polymer interactions which are guest-guest interactions.

In a different state, the solid solution state, the API and the polymer are miscible and the API dissolves to some extent within the polymer matrix. Such compositions have much smaller units of API—either strong bonded molecular complexes or single molecules—compared with phase separated and synthon solution compositions. Solid solution compositions are intimately mixed and, therefore, the coherent atom-atom pairs are API-API, polymer-polymer, API-polymer (host-guest) in approximately 1 to 1 to 1 ratios for a 1:1 mixture.

Another composition may exist where a preferred hydrogen bonding interaction takes place. This is the preferred bonding composition and may also be referred to as the “preferred bonding state.” For example, the API and the polymer may join together to form a synthon. For such a complex, the dominant coherent atom-atom interaction will be API-polymer with only negligible contributions from API-API and polymer-polymer components.

The different compositions and intermolecular component interactions can be characterized according to the invention. These characterizations are performed by utilizing the pairwise distribution function. The PDF is generally described in WO 2005/082050 A2 which is incorporated herein by reference in its entirety.

PDF plots may either be calculated or derived and the invention may use calculated, derived, or a combination of the two to characterize a composition. Calculated PDF plots originate from x-ray powder diffraction data. For example, in one embodiment of the invention, the PDF is calculated by obtaining measured powder diffraction data and then transforming the measured data into what is called a reduced structure factor (RSF) representation. Example 6 provides one example of calculating an RSF. This transformation removes the most significant instrumental contributions and normalizes the data to the mean atomic scattering power of the molecule. Once the RSF has been extracted, the PDF is calculated using a Fourier sine transform. Methods of obtaining the RSF can be found in WO 2005/082050 A2.

In the context of obtaining PDF plots, “derived” means that the PDF has not been directly calculated from the component or composition x-ray powder diffraction pattern. For example, the PDF could be obtained from single crystal data or it could be obtained by disordering a PDF collected from an x-ray powder diffraction pattern. The disordering may be done by means known to those of ordinary skill in the solid-state analytical arts such as by a random walk analysis.

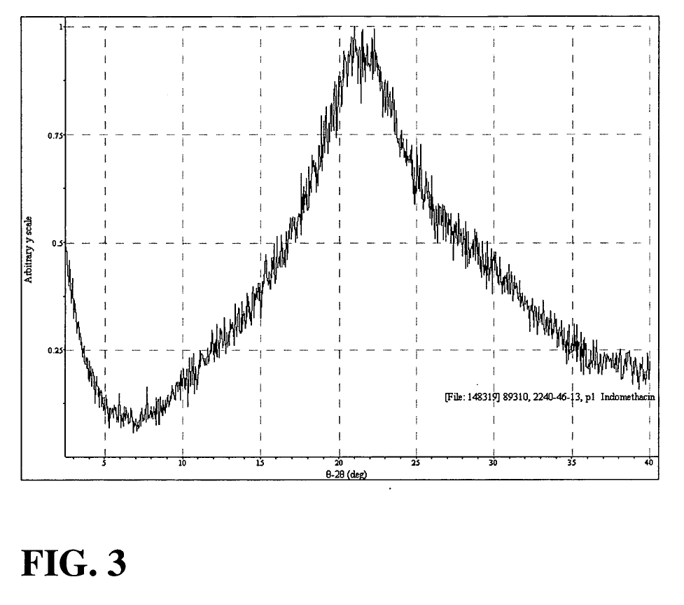

The PDF can be used to convert x-ray amorphous powder diffraction data into a plot whereby interactions between nearest neighbors are plotted as a function of the distance between them. Thus, in a crystal, one would expect to see a repeating pattern which is in fact what is seen in the crystalline PDF a crystalline substance which can be found as the top plot of FIG. 3 of WO 2005/082050. For a truly amorphous material, one not expect to see such oscillations over the length scale of a crystal. In practice, one often sees peaks in shorter ranges such as can be seen in a PDF which is illustrated in the bottom plot of FIG. 3 of WO 2005/082050.

PDFs can also be directly calculated from the known single crystal structure. This allows for an independent calibration of the computational methods as applied to measured data. Using the unit cell parameters and atomic coordinates from the single-crystal structure as input, the following expression is used to calculate the PDF, G(r) (S. J. L. Billinge and M. G. Kanatzidis, 7 Chem. Commun. 2004, 749-760, which is incorporated by reference herein):

$$G ( r ) + 4 π r {ρ}_{o} = \frac{1}{r} {\sum }_{v} {\sum }_{μ} \frac{{f ( 0 )}_{v} {f ( 0 )}_{μ}}{{〈 f ( 0 ) 〉}^{2}} δ ( r - {r}_{v μ} )$$

The double sum is over all atom pairs in the structure, evaluating the normalized product of the individual atomic scattering functions.

The calculation of the PDF transform for measured amorphous data produces both an RSF and a PDF plot. The RSF and PDF are directly related through the Fourier sine transform. This relationship is useful in analyzing mixtures and dispersions, because the linear addition of Fourier transforms is the Fourier transform of the linear combination according to a Fourier transform identity. For phase-separated systems, the scale factors for each component RSF are used to achieve the best fit to the composition RSF and are directly related to their relative weight fraction in the mixture. This observation acts as an additional test used to determine if the composition under consideration is phase separated.

In one embodiment of the invention, PDF plots were collected on two Indomethacin:PVP dispersion mixtures. In one case, the dispersion was 70:30 (w:w) Indomethacin:PVP and in the other it was 30:70 (w:w) Indomethacin:PVP. X-ray powder diffraction data were collected on the dispersions and on each of the components in the amorphous state. The x-ray powder diffraction data were transformed into PDF plots as discussed in the examples. A linear combination of PDFs was attempted on the dispersion but it resulted in a residual that was substantially greater than the noise in the PDF of either dispersion. This indicated that the dispersions were neither phase separated nor solid synthon solutions. It was determined by summing the absolute values of each of the points for each PDF that both dispersions had interactions containing contributions from indomethacin-indomethacin interactions, PVP-PVP interactions and indomethacin-PVP interactions. Thus, the dispersions were determined to be solid solutions.

The following examples are merely exemplary embodiments of the invention and are not meant to be limiting.

### EXAMPLES

Materials

Indomethacin (Lot no. 064K1207) and polyvinylpyrrolidone, PVP-K90 (Lot no. 02413DC, average molecular weight=1,000,000 g/mol) were obtained from Sigma Chemical Company (St. Louis, Mo.) and used as received.

1. Preparation of Amorphous Indomethacin

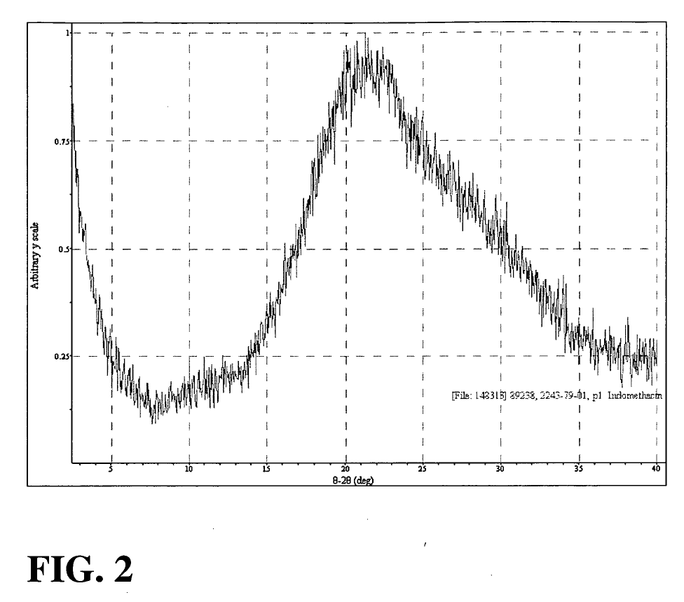

Approximately 1.0 gram of indomethacin (gamma polymorph) was weighed into an uncapped glass scintillation vial. The vial was submerged into an oil bath heated to approximately 180° C. for 5 minutes. The melted solid was submerged into a liquid nitrogen bath for approximately two minutes. The vial was capped and placed into a nitrogen bag to warm to room temperature. The solid was lightly ground with a spatula and placed into an ambient vacuum oven for one day to remove any residual solvent. The resulting solids were yellow in color and did not exhibit birefringence by optical microscopy. The sample was stored over P₂O₅ at sub-ambient (freezer) conditions. The sample was analyzed by X-ray powder diffraction for further analyses. (FIG. 2)

2. Preparation of Indomethacin:PVP Amorphous Dispersions in a 70:30 w:w Mixture

Approximately 1.0 gram of indomethacin (was dissolved in 20 mL of dichloromethane. Approximately 435 mg of PVP-K90 was added to the indomethacin solution and stirred on a stir plate until all of the solids dissolved. The resulting solution was filtered through a 0.2 μm nylon filter into a 50 mL round bottom flask. The solution was flash evaporated by rotary evaporation at 50° C. The resulting solids were collected and placed into a vacuum oven set at approximately 40° C. for one day to remove any residual solvent. The solids were yellow in color with a flake morphology. The solids also did not exhibit any birefringence by optical microscopy. The sample was stored over P₂O₅ at sub-ambient (freezer) conditions. The sample was analyzed by X-ray powder diffraction for further analyses. (FIG. 3)

3. Preparation of Indomethacin:PVP in a 30:70, w:w Mixture

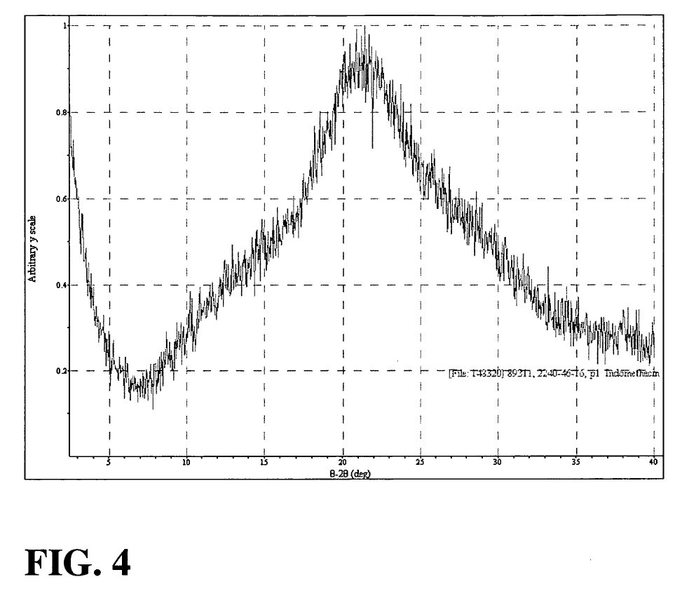

Approximately 1.0 gram of indomethacin was dissolved in 20 mL of dichloromethane. Approximately 2.3 grams of PVP-K90 was added to the indomethacin solution. An additional 20 mL of dichloromethane was added to the sample and stirred on a stir plate until all of the solids dissolved. The resulting solution was filtered through a 0.2 μm nylon filter into a round bottom flask. The solution was flash evaporated by rotary evaporation at 50° C. The resulting solids were collected and placed into a vacuum oven set at approximately 40° C. for one day to remove any residual solvent. The solids were yellow in color with a flake morphology. The solids also did not exhibit any birefringence by optical microscopy. The sample was stored over P₂O₅ at sub-ambient (freezer) conditions. The sample was analyzed by X-ray powder diffraction for further analyses. (FIG. 4.)

4. X-ray Powder Diffraction Methods

XRPD analyses were performed using a Shimadzu XRD-6000 X-ray powder diffractometer (Kyoto, Japan) using Cu Kα radiation. The Bragg-Brentano reflection geometry gives a much lower background signal that is easier to model and remove from the diffuse x-ray amorphous contribution. The Shimadzu instrument is equipped with a long fine focus X-ray tube. The tube voltage and amperage were set to 40 kV and 40 mA, respectively. The divergence and scattering slits were set at 1° and the receiving slit was set at 0.15 mm. Diffracted radiation was detected by a NaI scintillation detector. A θ-2θ continuous scan at 1.2°/min from 2.5 to 60° 2θ was used with an effective 0.04 step size. The analysis was performed at ambient temperature. A silicon standard was analyzed to check the instrument alignment. Data were collected and analyzed using XRD-6100/7000 v. 5.0. Samples were prepared for analysis by placing them in an aluminum reflection sample holder with low background silicon inserts. The dimensions of the sample well are approximately 10 mm in diameter and 2 mm in depth.

5. Processing the XRPD Data

The algorithm used to analyze the X-ray diffraction data took as input the measured XRPD data and the compound formula—C₁₉H₁₆ClNO₄ for indomethacin. The XRPD patterns were smoothed to reduce noise using an automatic algorithm that monitors the variance of the pattern (as an estimate of the noise level) and keeps smoothing until a desired empirically determined threshold is reached. In the case of indomethacin and indomethacin:PVP compositions that threshold was 0.005. Variance was computed by stepping through the pattern in 2 degree windows, centered at each point, computing the variance, and keeping the lowest variance (of all the windows) as the noise estimate for the entire pattern.

For each atom in each compound, whether indomethacin alone or in the composition, and at each measured position in Q space, the algorithm looked up the published Atomic and Compton scattering factors in published tables from B. E. Warren, X-ray diffraction, Dover Publications, NY, 1990. Since the tables only cover a handful of Q values, the factors are linearly interpolated to cover the rest of the Q range present in measured data.

The instrument background used to collect the XRPD data consists of a linear component of unknown intensity and a Lorentzian leading edge with unknown full width at half maximum (FWHM) and unknown intensity. Therefore this portion of the background was modeled using three variables: linear intensity, FWHM, and a lorentzian intensity scale factor. The linear and lorentzian components were added together to form the instrument background which was directly subtracted from the measured data before computing the sample background.

The sample background was computed starting with the subtracted data by applying the Polarization correction: (1+cos 2(2θ))/2, and the instrument correction (based on sample holder radius and beam width). This corrected data was then converted from counts to electron density units. Finally, a thermal correction was applied as follows: f=f0*exp [−B sin 2θ/λ2], where f0 is the atomic scattering factor, B is the Debye-Waller temperature factor (which is another variable in the algorithm) and λ is the wavelength of the source. This sample correction was summed with the Compton scattering factor and finally scaled by the fifth and final variable in the algorithm. The resulting total background (instrument+sample) was compared to the measured pattern and an error was computed (typically sum-squared differences at each point, penalizing additionally for any points where the background intensity exceeds measured intensity). The five variables were determined iteratively by extensive calculations.

6. Calculating a Reduced Structure Factor

After smoothing and background correction, the measured data was corrected for Polarization and instrument effects, as described in example 5. The corrected data was then scaled using a variable factor and dampened using a variable exponential damping term. The measured pattern was then back-calculated without the damping term to establish the error related to the damping. This procedure was repeated for a reasonable range of damping values to find the one that produces the least amount of artifacts in the Reduced Structure Factor (RSF) without the loss of actual features. Finally the RSF was scaled until a reasonable target density was achieved because given the compound formula, the density can be estimated. This scale factor was another variable in the search algorithm.

The RSF was terminated in the final calculated PDF by fitting a sine function to the start and end of the RSF in such fashion as to terminate around zero intensity on both ends. The procedure was fully automatic.

A range of the two variables (damping term and scale factor) was explored until the best RSF was found, as determined by the error in the back-calculated pattern and how close the calculated density was to the estimated density.

7. Calculating a PDF from the RSF

The PDF of the best RSF was computed by applying a Fourier transform. This was the final output of the algorithm. For all points r over which the PDF is computed

$$PDF ( r ) = \frac{2}{π} {\sum }_{Q} {Q}_{y} * sin ( {Q}_{x} * r )$$

8. Fitting the PDFs

The fitting of linear combinations of the PDF from indomethacin and PVP to the PDF derived from the dispersion was performed using Microsoft Excel®.

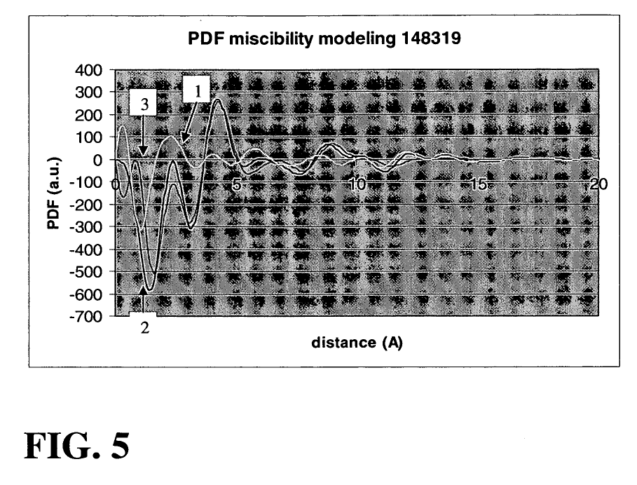

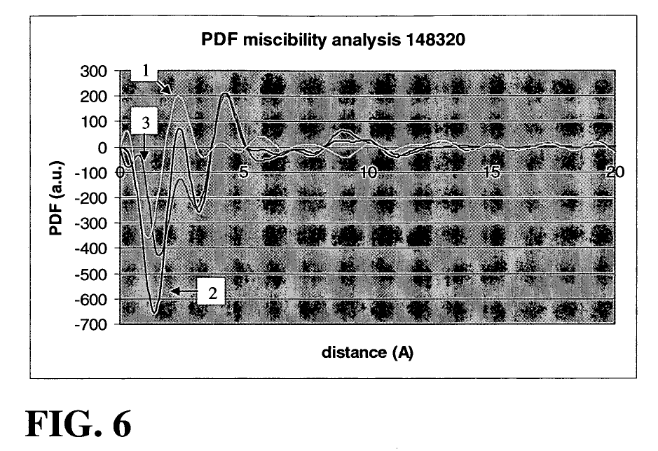

FIGS. 5 and 6 show the resulting miscibility analysis in Excel. In both cases the fit to the dispersion PDF is poor, giving incorrect weight percents and a large residual that appears like an additional PDF contribution. This is taken to be clear evidence of miscibility, where the residual represents the unknown API-Polymer interaction. The relative contributions of API-API, polymer-polymer and API-Polymer interactions can be extracted from the linear combination calculations to give some idea of the degree of miscibility.

For data set 148319, the IMC percentage was nominally 70% with 30% PVP. The IMC weight percent assuming a phase separated was measured to be ˜46%. The miscibility indicates ˜50% API-API interaction, 25% Polymer-Polymer interaction and 25% Polymer-API interaction.

Data set 148320 has nominal IMC percentage of 30% with the Polymer at 70%. Assuming phase separation, the API weight percent is measured to be ˜22%. The miscibility indicated ˜22% API-API, 55% Polymer-Polymer and 33% Polymer-API interaction.

In both figures, the residual is the PDF plot line 1, line 2 is the PDF plot of the purported dispersion, and line 3 is the PDF plot of the linear combination of Indomethacin and PVP.

1. A process for characterizing a composition comprising linearly combining pairwise distribution function plots of the principal components of a composition and comparing the plots with the pairwise distribution function plot of the composition to obtain a description of the composition.

2. The process of claim 1 wherein the composition is amorphous.

3. The process of claim 1 wherein the description is selected from phase separated, solid solution, preferred bonding, and synthon solution.

4. The process of claim 1 wherein the composition is crystalline, amorphous or a combination thereof.

5. The process of claim 1 where a pairwise distribution function is collected for all but one of the principal components.

6. A method for characterizing a composition comprising obtaining a pairwise distribution function plot for a composition; obtaining pairwise distribution plot for each of the principal components wherein the plot for at least one principal component was derived; linearly combining the pairwise distribution function plots of the principal components and comparing them with the pairwise distribution function plot of the composition to obtain a description of the structure of the composition.

7. A method for characterizing a composition comprising obtaining an x-ray powder diffraction pattern on a composition; obtaining a pairwise distribution function plot of the x-ray powder diffraction pattern of the composition; obtaining x-ray powder diffraction patterns on principal components of the composition; obtaining pairwise distribution function plots of each of the components and of the composition; linearly combining the pairwise distribution function plots of the components and linearly combining said plots with the plot of the pairwise distribution function of the composition to obtain a description of the structure of the composition.

8. The method of claims 1 or 8 wherein the composition is a two principal component mixture.

9. The method of claims 1 or 8 wherein one principal component is a stabilizer.

10. The method of claim 9 wherein the stabilizer is selected from a polymer, a cellulose derivative, or an organic acid.

11. The method of claim 10 wherein a principal component is an organic compound.

13. The method of claim 11 wherein a principal component is an active pharmaceutical ingredient.

14. The method of claim 13 where the composition has three or more principal components.

15. The method of claim 8 wherein the composition is selected from amorphous, crystalline, or a combination thereof.

16. The method of claim 10 wherein the stabilizer is selected from PVP, HPMC, and citric acid.
